(19) United States
(12) Patent Application Publication
(10) Pub. No.: US 2025/0184183 A1
(43) Pub. Date: Jun. 5, 2025

(54) LOCAL AREA NETWORK CONTROL SYSTEM BASED ON BLUETOOTH AND USER DATAGRAM PROTOCOL AND METHOD THEREOF

(71) Applicant: Xiamen PVTECH Co., Ltd., Xiamen (CN)

(72) Inventors: FUXING LU, Xiamen (CN); Zhenhui Wu, Xiamen (CN)

(73) Assignee: Xiamen PVTECH Co., Ltd., Xiamen (CN)

(21) Appl. No.: 18/963,513

(22) Filed: Nov. 28, 2024

(30) Foreign Application Priority Data
Dec. 1, 2023 (CN) 202311649029.8

(51) Int. Cl. H04L 12/66; H04W 4/80

(52) U.S. Cl. CPC H04L 12/66; H04W 4/80

(57) ABSTRACT

A local area network control system based on Bluetooth and user datagram protocol (UDP), which includes a plurality of first Bluetooth devices, a first gateway, a plurality of second Bluetooth devices, a second gateway, and a control device. The first gateway manages the first Bluetooth devices. The second gateway manages the second Bluetooth devices. The first gateway broadcasts an information exchange request message based on UDP. The second gateway receives and analyzes the information exchange request message to obtain the gateway information of the first gateway, and return an information message based on UDP to the first gateway. The first gateway receives and analyzes the information message to obtain the gateway information of the second gateway. The control device controls one or more of the first Bluetooth devices and the second Bluetooth devices via either the first gateway or the second gateway.

### BACKGROUND OF THE INVENTION

### 1. Field of the Invention

The present invention relates to a local area network control system, in particular to a local area network control system based on Bluetooth and user datagram protocol (UDP). The present invention further relates to the method of the local area network control system.

### 2. Description of the Prior Art

In a local area network (LAN) environment such as home, office, or science park, a user typically needs to control multiple devices, such as lighting, audio systems, televisions, etc. However, the user often needs to use different applications or remote controls to manage these devices, so the user should switch between various interfaces. This control method is not only highly inconvenient to use but also significantly inefficient.

To address this issue, centralized control solutions have emerged. These solutions can greatly enhance convenience and efficiency, allowing users to more easily control and manage various devices within a LAN in homes, offices, and similar settings. However, these centralized control solutions typically require cloud services, which substantially increase the costs associated with these solutions.

China Patent Publication No.: CN116074398A and China Patent Publication No. CN116266905A also disclose relevant techniques, but these techniques still fail to effectively solve the above problems.

### SUMMARY OF THE INVENTION

One embodiment of the present invention provides a local area network control system based on Bluetooth and user datagram protocol (UDP), which includes a plurality of first Bluetooth devices, a first gateway, a plurality of second Bluetooth devices, a second gateway, and a control device. The first gateway manages the first Bluetooth devices. The second gateway manages the second Bluetooth devices. The first gateway broadcasts an information exchange request message based on UDP. The second gateway receives and analyzes the information exchange request message to obtain the gateway information of the first gateway, and return an information message based on UDP to the first gateway. The first gateway receives and analyzes the information message to obtain the gateway information of the second gateway. The control device controls one or more of the first Bluetooth devices and the second Bluetooth devices via either the first gateway or the second gateway.

In one embodiment, the gateway information of the first gateway includes the Internet address of the first gateway and the routing information of the first Bluetooth devices.

In one embodiment, the local area network control system further includes a second local database. The second gateway saves the routing information of the first Bluetooth devices in the second local database and returns the information message to the first gateway in unicast manner based on UDP according to the Internet address of the first gateway, such that the second gateway has the routing information of the first Bluetooth devices and the routing information of the second Bluetooth devices.

In one embodiment, the gateway information of the second gateway includes the Internet address of the second gateway and the routing information of the second Bluetooth devices.

In one embodiment, the local area network control system further includes a first local database. The first gateway saves the routing information of the second Bluetooth devices in the first local database and return a confirmation message to the second gateway in unicast manner based on UDP according to the Internet address of the second gateway, such that the first gateway has the routing information of the first Bluetooth devices and the routing information of the second Bluetooth devices.

Another embodiment of the present invention provides a local area network control method based on Bluetooth and UDP, which includes the following steps: broadcasting an information exchange request message based on UDP by a first gateway for managing a plurality of first Bluetooth devices; receiving and analyzing the information exchange request message by a second gateway for managing a plurality of second Bluetooth devices to obtain the gateway information of the first gateway, and returning an information message based on the user datagram protocol to the first gateway; receiving and analyzing the information message by the first gateway to obtain the gateway information of the second gateway; and controlling one or more of the first Bluetooth devices and the second Bluetooth devices by a control device via either the first gateway or the second gateway.

In one embodiment, the gateway information of the first gateway includes the Internet address of the first gateway and the routing information of the first Bluetooth devices.

In one embodiment, the step of receiving and analyzing the information exchange request message by the second gateway configured to manage the second Bluetooth devices to obtain the gateway information of the first gateway, and returning the information message based on the user datagram protocol to the first gateway further includes the following steps: saving the routing information of the first Bluetooth devices in a second local database via the second gateway; and returning the information message to the first gateway in unicast manner based on UDP according to the Internet address of the first gateway by the second gateway, such that the second gateway has the routing information of the first Bluetooth devices and the routing information of the second Bluetooth devices.

In one embodiment, the gateway information of the second gateway includes the Internet address of the second gateway and the routing information of the second Bluetooth devices.

In one embodiment, the method further includes the following steps: saving the routing information of the second Bluetooth devices in a first local database by the first gateway; and returning a confirmation message to the second gateway in unicast manner based on UDP according to the Internet address of the second gateway by the first gateway, such that the first gateway has the routing information of the first Bluetooth devices and the routing information of the second Bluetooth devices.

The local area network control system based on Bluetooth and UDP, and the method thereof in accordance with the embodiments of the present invention may have the following advantages:

(1) In one embodiment of the present invention, the local area network control system includes a plurality of first Bluetooth devices, a first gateway, a plurality of second Bluetooth devices, a second gateway, and a control device. The first gateway manages the first Bluetooth devices. The second gateway manages the second Bluetooth devices. The first gateway broadcasts an information exchange request message based on UDP. The second gateway receives and analyzes the information exchange request message to obtain the gateway information of the first gateway, and return an information message based on UDP to the first gateway. The first gateway receives and analyzes the information message to obtain the gateway information of the second gateway. The control device controls one or more of the first Bluetooth devices and the second Bluetooth devices via either the first gateway or the second gateway. Through this control mechanism, all gateways in the local area network can obtain the routing information for all Bluetooth devices within the local area network, such that the control device can control all Bluetooth devices in the local area network through any gateway. As a result, the control device achieves centralized control, so the system can be more convenient in use and of high efficiency.

(2) In one embodiment of the present invention, the local area network control system can effectively integrate Bluetooth mesh network and UDP, so the control device can control all Bluetooth devices in the local area network through any gateway without the need for cloud services, thereby achieving centralized control. This significantly reduces the cost of the local area network control system, such that the local area network control system can be more comprehensive in application in order to meet various needs.

(3) In one embodiment of the present invention, the local area network control system can effectively integrate Bluetooth mesh network and UDP, so the local area network control system can be more flexible in application and more convenient in management. Therefore, the local area network control system can conform to actual needs.

(4) In one embodiment of the present invention, the local area network control system can effectively integrate Bluetooth mesh networking and UDP, and provide a unique control mechanism. This enables the control device, when WiFi signals are strong, to obtain the routing information for all Bluetooth devices in the local area network based on UDP through any gateway, and when WiFi signals are weak, to obtain the routing information for all Bluetooth devices in the local area network based on the Bluetooth communication protocol through any gateway. In this way, the control device can control all Bluetooth devices in the local area network. Therefore, the local area network control system can achieve high practicality and reliability.

(5) In one embodiment of the present invention, the local area network control system effectively provides centralized control, meeting the needs of most users and supporting various intelligent applications. As a result, the local area network control system aligns with future development trends.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is the schematic view of the local area network control method based on Bluetooth and user datagram protocol (UDP) in accordance with the first embodiment of the present invention.

FIG. 2 is the schematic view of the first operating state of the local area network control method based on Bluetooth and UDP in accordance with the first embodiment of the present invention.

FIG. 3 is the schematic view of the second operating state of the local area network control method based on Bluetooth and UDP in accordance with the first embodiment of the present invention.

FIG. 4 is the schematic view of the third operating state of the local area network control method based on Bluetooth and UDP in accordance with the first embodiment of the present invention.

FIG. 5 is the schematic view of the fourth operating state of the local area network control method based on Bluetooth and UDP in accordance with the first embodiment of the present invention.

FIG. 6 is the flow chart of the local area network control method based on Bluetooth and UDP in accordance with the second embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

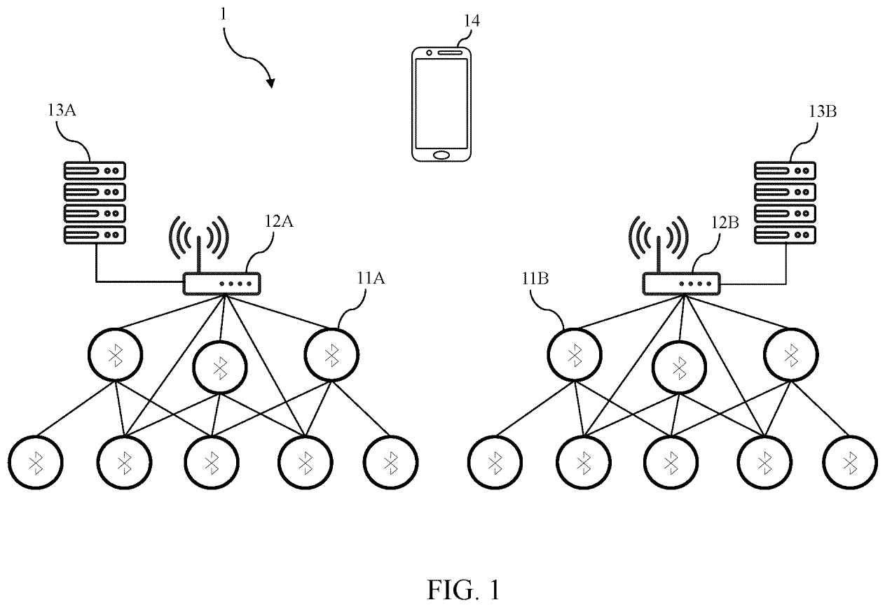

Please refer to FIG. 1, which is the schematic view of the local area network control method based on Bluetooth and user datagram protocol (UDP) in accordance with the first embodiment of the present invention. As shown in FIG. 1, the local area network control system 1 includes a plurality of first Bluetooth devices 11A, a first gateway 12A, a first local database 13A, a plurality of second Bluetooth devices 11B, a second gateway 12B, a second local database 13B, and a control device 14. The number of gateways and Bluetooth devices mentioned here is for illustration purposes and can be adjusted according to actual requirements. This invention is not limited to this specific configuration.

The first gateway 12A is a Bluetooth mesh network gateway that manages the first Bluetooth devices 11A. In one embodiment, these first Bluetooth devices 11A can include televisions, fans, sound systems, computers, lighting devices, or similar devices.

The first local database 13A is connected to the first gateway 12A. In one embodiment, the first local database 13A may be an SQLite database. In another embodiment, the first local database 13A may also be a MySQL database, a PostgreSQL database, or an H2 database.

The second gateway 12B is also a Bluetooth mesh network gateway that manages the second Bluetooth devices 11B. In one embodiment, these second Bluetooth devices 11B can include televisions, fans, sound systems, computers, lighting devices, or similar devices.

The second local database 13B is connected to the second gateway 12B. In one embodiment, the second local database 13B may be an SQLite database. In another embodiment, the second local database 13B may also be a MySQL database, a PostgreSQL database, or an H2 database.

The control device 14 can communicate with both the first gateway 12A and the second gateway 12B. In one embodiment, the control device 14 is a smartphone. In another embodiment, it may be a tablet computer, smartwatch, laptop, or other similar devices.

The embodiment just exemplifies the present invention and is not intended to limit the scope of the present invention; any equivalent modification and variation according to the spirit of the present invention is to be also included within the scope of the following claims and their equivalents.

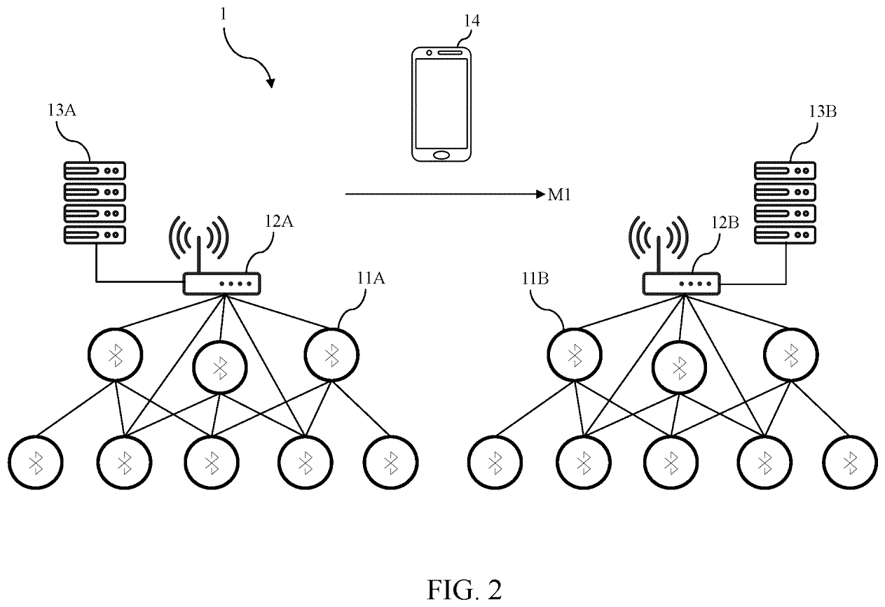

Please refer to FIG. 2, which is the schematic view of the first operating state of the local area network control method based on Bluetooth and UDP in accordance with the first embodiment of the present invention. As shown in FIG. 2, the first gateway 12A initially broadcasts an information exchange request message based on UDP. Since the first gateway 12A does not have information about other gateways in this local area network, the first gateway 12A needs to broadcast the information exchange request message M1 based on UDP. The information exchange request message M1 includes the gateway information of the first gateway 12A, which includes the Internet (IP) address of the first gateway 12A and the routing information (topology information) for the first Bluetooth devices 11A.

The embodiment just exemplifies the present invention and is not intended to limit the scope of the present invention; any equivalent modification and variation according to the spirit of the present invention is to be also included within the scope of the following claims and their equivalents.

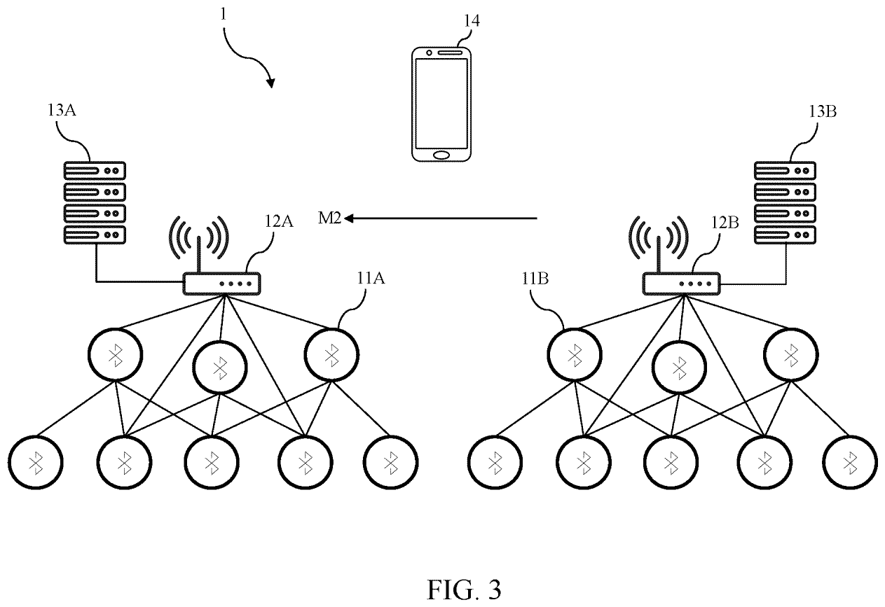

Please refer to FIG. 3, which is the schematic view of the second operating state of the local area network control method based on Bluetooth and UDP in accordance with the first embodiment of the present invention. As shown in FIG. 3, the second gateway 12B receives the information exchange request message M1 and analyzes which to obtain the gateway information of the first gateway 12A (including the Internet address of the first gateway 12A and the routing information of the first Bluetooth devices 11A). Then, the second gateway 12B saves the routing information of the first Bluetooth devices 11A in the first local database 13A. In this way, the second gateway 12B can acquire the routing information for all Bluetooth devices within the local area network (i.e., the first Bluetooth devices 11A and the second Bluetooth devices 11B). Next, the second gateway 12B returns an information message M2 to the first gateway 12A in unicast manner based on UDP according to the Internet address of the first gateway 12A. The information message M2 includes the gateway information of the second gateway 12B, which contains the Internet address of the second gateway 12B and the routing information (topology information) for the second Bluetooth devices 11B.

Since the second gateway 12B has already obtained the Internet address of the first gateway 12A, the second gateway 12B can directly return the information message M2 to the first gateway 12A in unicast manner based on UDP, thus reducing bandwidth usage in the local area network.

The embodiment just exemplifies the present invention and is not intended to limit the scope of the present invention; any equivalent modification and variation according to the spirit of the present invention is to be also included within the scope of the following claims and their equivalents.

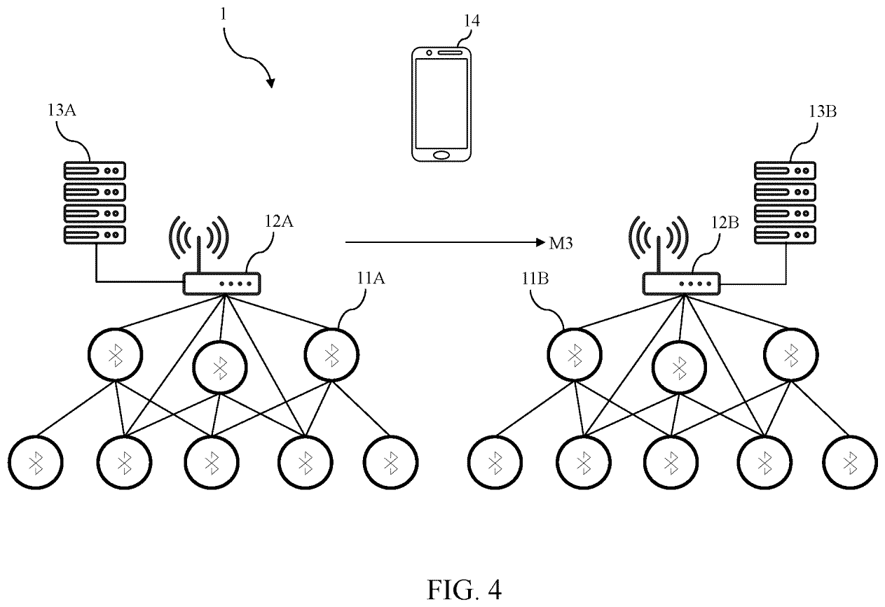

Please refer to FIG. 4, which is the schematic view of the third operating state of the local area network control method based on Bluetooth and UDP in accordance with the first embodiment of the present invention. As shown in FIG. 4, the first gateway 12A receives the information message M2 and analyze with to obtain the gateway information of the second gateway 12B (including the Internet address of the second gateway 12B and the routing information of the second Bluetooth devices 11B). Then, the first gateway 12A saves the routing information of the second Bluetooth devices 11B in the second local database 13B. In this way, the first gateway 12A can also obtain the routing information for all Bluetooth devices in the local area network (i.e., the first Bluetooth devices 11A and the second Bluetooth devices 11B). Next, the first gateway 12A returns a confirmation message M3 to the second gateway 12B in unicast manner based on UDP using the Internet address of the second gateway 12B.

Similarly, since the first gateway 12A has already obtained the Internet address of the second gateway 12B, the first gateway 12A can directly return the confirmation message M3 to the second gateway 12B in unicast manner based on UDP to reduce bandwidth usage in the local area network.

If the second gateway 12B does not receive the confirmation message M3 from the first gateway 12A, the second gateway 12B periodically sends information message M2 to the first gateway 12A in unicast manner based on UDP. Once the second gateway 12B receives the confirmation message M3 from the first gateway 12A, the second gateway 12B stops periodically sending information message M2.

Through this mechanism, any gateway within the local area network can obtain the routing information for all Bluetooth devices in the local area network. Consequently, the control device 14 can control all Bluetooth devices in the local area network via any gateway, achieving centralized control functionality.

The embodiment just exemplifies the present invention and is not intended to limit the scope of the present invention; any equivalent modification and variation according to the spirit of the present invention is to be also included within the scope of the following claims and their equivalents.

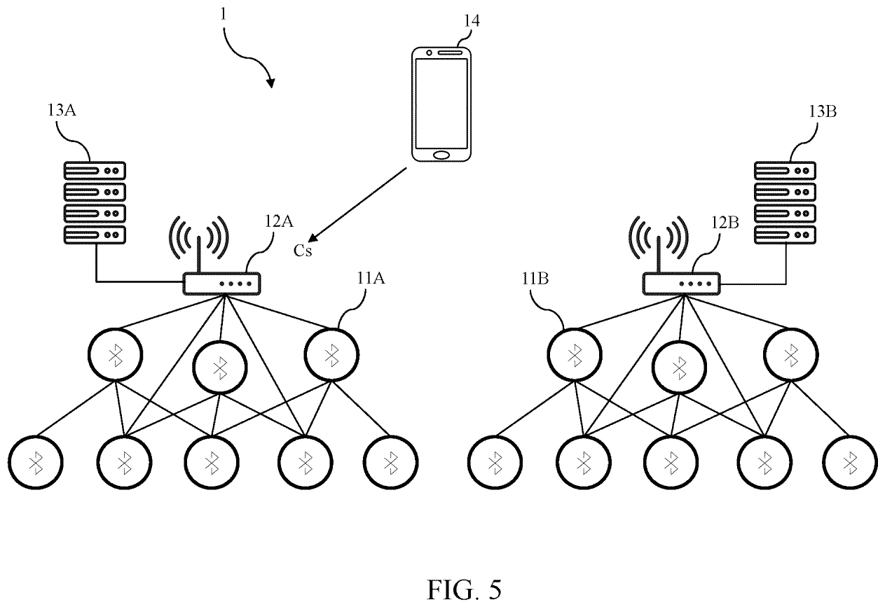

Please refer to FIG. 5, which is the schematic view of the fourth operating state of the local area network control method based on Bluetooth and UDP in accordance with the first embodiment of the present invention. As shown in FIG. 5, the control device 14 can send a control signal Cs to the first gateway 12A (or the second gateway 12B) to obtain the routing information for all Bluetooth devices in the local area network (i.e., the first Bluetooth devices 11A and the second Bluetooth devices 11B) and control any Bluetooth device in the local area network, achieving centralized control functionality.

If the WiFi signal is strong, the control device 14 sends the control signal Cs to the first gateway 12A (or the second gateway 12B) based on UDP. If the Wifi signal is weak, the control device 14 sends the control signal Cs to the first gateway 12A (or the second gateway 12B) based on Bluetooth communication protocol. In this way, the control device 14 can control all Bluetooth devices in the local area network, thus enhancing the practicality and reliability of the local area network control system 1.

If a third gateway, which manages a plurality of third Bluetooth devices (and connects to a third local database), is added to this local area network control system 1, the third gateway can perform the same operating mechanism as the first gateway 12A. For example, the third gateway broadcasts an information exchange request message based on UDP. This information exchange request message includes the gateway information of the third gateway, which includes the Internet address of the third gateway and the routing information (topology information) for the third Bluetooth devices.

The first gateway 12A then receives and analyzes this information exchange request message to obtain the gateway information of the third gateway (including the Internet address of the third gateway and the routing information for the third Bluetooth devices), and the first gateway 12A saves the routing information for the third Bluetooth devices in the first local database 13A. Similarly, the second gateway 12B receives and analyzes the information exchange request message to obtain the gateway information of the third gateway and saves the routing information for the third Bluetooth devices in the second local database 13B.

Since the first gateway 12A and the second gateway 12B have obtained the Internet address of the third gateway, the first gateway 12A and the second gateway 12B can directly return an information message to the third gateway in unicast manner based on UDP.

Next, the third gateway receives and analyzes the information message to obtain the gateway information of the first gateway 12A (including the Internet address of the first gateway 12A and routing information of the first Bluetooth devices 11A) and the gateway information of the second gateway 12B (including the Internet address of the second gateway 12B and routing information of the second Bluetooth devices 11B).

Finally, the third gateway saves the routing information of the first Bluetooth devices 11A and the second Bluetooth devices 11B in the third local database and returns confirmation messages to the first gateway 12A and the second gateway 12B.

Through the above mechanism, all gateways in the local area network can obtain the routing information for all Bluetooth devices in the local area network, enabling the control device 14 to control all Bluetooth devices in the local area network via any gateway. Therefore, the control device 14 achieves centralized control functionality, making operation more convenient and efficient.

Additionally, in this embodiment, the local area network control system 1 can effectively integrate the Bluetooth mesh network and UDP, such that the control device 14 can control all Bluetooth devices in the local area network through any gateway without requiring cloud services. This achieves centralized control functionality, significantly reducing the cost of the local area network control system 1 and making it more broadly applicable to various usage scenarios.

Furthermore, in this embodiment, the local area network control system 1 can effectively integrate the Bluetooth mesh network and UDP, offering greater flexibility in application and easier management. Therefore, the local area network control system 1 can meet practical application requirements.

The embodiment just exemplifies the present invention and is not intended to limit the scope of the present invention; any equivalent modification and variation according to the spirit of the present invention is to be also included within the scope of the following claims and their equivalents.

It is worthy to point out that the currently available centralized control solutions typically require cloud services, which substantially increase the costs associated with these solutions. By contrast, according to one embodiment of the present invention, the local area network control system includes a plurality of first Bluetooth devices, a first gateway, a plurality of second Bluetooth devices, a second gateway, and a control device. The first gateway manages the first Bluetooth devices. The second gateway manages the second Bluetooth devices. The first gateway broadcasts an information exchange request message based on UDP. The second gateway receives and analyzes the information exchange request message to obtain the gateway information of the first gateway, and return an information message based on UDP to the first gateway. The first gateway receives and analyzes the information message to obtain the gateway information of the second gateway. The control device controls one or more of the first Bluetooth devices and the second Bluetooth devices via either the first gateway or the second gateway. Through this control mechanism, all gateways in the local area network can obtain the routing information for all Bluetooth devices within the local area network, such that the control device can control all Bluetooth devices in the local area network through any gateway. As a result, the control device achieves centralized control, so the system can be more convenient in use and of high efficiency.

Also, according to one embodiment of the present invention, the local area network control system can effectively integrate Bluetooth mesh network and UDP, so the control device can control all Bluetooth devices in the local area network through any gateway without the need for cloud services, thereby achieving centralized control. This significantly reduces the cost of the local area network control system, such that the local area network control system can be more comprehensive in application in order to meet various needs.

Further, according to one embodiment of the present invention, the local area network control system can effectively integrate Bluetooth mesh network and UDP, so the local area network control system can be more flexible in application and more convenient in management. Therefore, the local area network control system can conform to actual needs.

Moreover, according to one embodiment of the present invention, the local area network control system can effectively integrate Bluetooth mesh networking and UDP, and provide a unique control mechanism. This enables the control device, when WiFi signals are strong, to obtain the routing information for all Bluetooth devices in the local area network based on UDP through any gateway, and when WiFi signals are weak, to obtain the routing information for all Bluetooth devices in the local area network based on the Bluetooth communication protocol through any gateway. In this way, the control device can control all Bluetooth devices in the local area network. Therefore, the local area network control system can achieve high practicality and reliability.

Furthermore, according to one embodiment of the present invention, the local area network control system effectively provides centralized control, meeting the needs of most users and supporting various intelligent applications. As a result, the local area network control system aligns with future development trends. As described above, the local area network control system according to the embodiments can definitely achieve great technical effects.

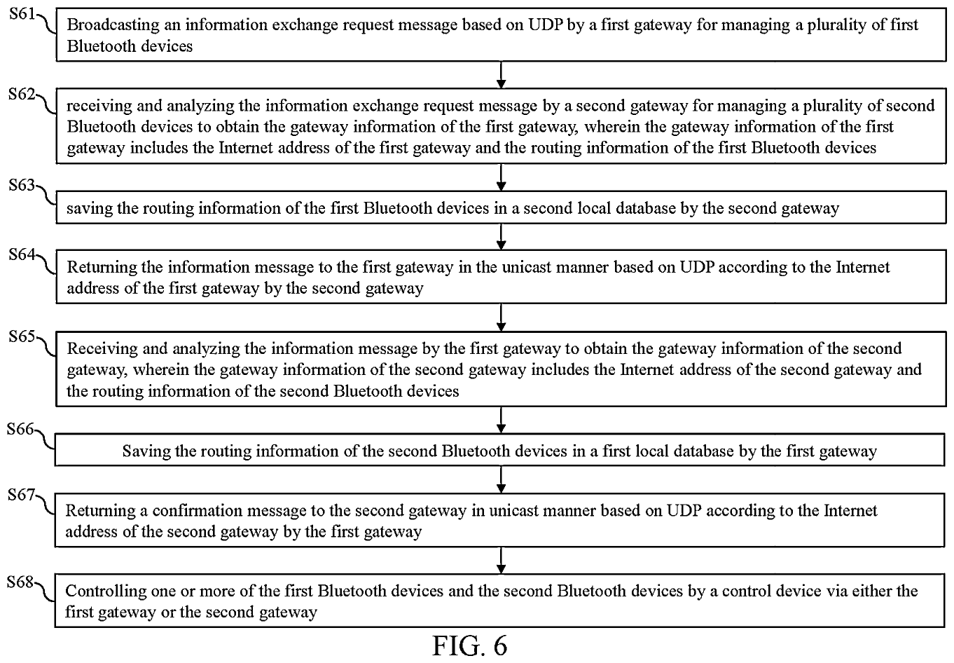

Please refer to FIG. 6, which is the flow chart of the local area network control method based on Bluetooth and UDP in accordance with the second embodiment of the present invention. As shown in FIG. 6, the local area network control method of the embodiment includes the following steps:

Step S61: broadcasting an information exchange request message based on UDP by a first gateway for managing a plurality of first Bluetooth devices.

Step S62: receiving and analyzing the information exchange request message by a second gateway for managing a plurality of second Bluetooth devices to obtain the gateway information of the first gateway, wherein the gateway information of the first gateway includes the Internet address of the first gateway and the routing information of the first Bluetooth devices.

Step S63: saving the routing information of the first Bluetooth devices in a second local database by the second gateway.

Step S64: returning the information message to the first gateway in the unicast manner based on UDP according to the Internet address of the first gateway by the second gateway.

Step S65: receiving and analyzing the information message by the first gateway to obtain the gateway information of the second gateway, wherein the gateway information of the second gateway includes the Internet address of the second gateway and the routing information of the second Bluetooth devices.

Step S66: saving the routing information of the second Bluetooth devices in a first local database by the first gateway.

Step S67: returning a confirmation message to the second gateway in unicast manner based on UDP according to the Internet address of the second gateway by the first gateway.

Step S68: controlling one or more of the first Bluetooth devices and the second Bluetooth devices by a control device via either the first gateway or the second gateway.

The embodiment just exemplifies the present invention and is not intended to limit the scope of the present invention; any equivalent modification and variation according to the spirit of the present invention is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

To sum up, according to one embodiment of the present invention, the local area network control system includes a plurality of first Bluetooth devices, a first gateway, a plurality of second Bluetooth devices, a second gateway, and a control device. The first gateway manages the first Bluetooth devices. The second gateway manages the second Bluetooth devices. The first gateway broadcasts an information exchange request message based on UDP. The second gateway receives and analyzes the information exchange request message to obtain the gateway information of the first gateway, and return an information message based on UDP to the first gateway. The first gateway receives and analyzes the information message to obtain the gateway information of the second gateway. The control device controls one or more of the first Bluetooth devices and the second Bluetooth devices via either the first gateway or the second gateway. Through this control mechanism, all gateways in the local area network can obtain the routing information for all Bluetooth devices within the local area network, such that the control device can control all Bluetooth devices in the local area network through any gateway. As a result, the control device achieves centralized control, so the system can be more convenient in use and of high efficiency.

Also, according to one embodiment of the present invention, the local area network control system can effectively integrate Bluetooth mesh network and UDP, so the control device can control all Bluetooth devices in the local area network through any gateway without the need for cloud services, thereby achieving centralized control. This significantly reduces the cost of the local area network control system, such that the local area network control system can be more comprehensive in application in order to meet various needs.

Further, according to one embodiment of the present invention, the local area network control system can effectively integrate Bluetooth mesh network and UDP, so the local area network control system can be more flexible in application and more convenient in management. Therefore, the local area network control system can conform to actual needs.

Moreover, according to one embodiment of the present invention, the local area network control system can effectively integrate Bluetooth mesh networking and UDP, and provide a unique control mechanism. This enables the control device, when WiFi signals are strong, to obtain the routing information for all Bluetooth devices in the local area network based on UDP through any gateway, and when WiFi signals are weak, to obtain the routing information for all Bluetooth devices in the local area network based on the Bluetooth communication protocol through any gateway. In this way, the control device can control all Bluetooth devices in the local area network. Therefore, the local area network control system can achieve high practicality and reliability.

Furthermore, according to one embodiment of the present invention, the local area network control system effectively provides centralized control, meeting the needs of most users and supporting various intelligent applications. As a result, the local area network control system aligns with future development trends.

It will be apparent to those skilled in the art that various modifications and variations can be made to the disclosed embodiments. It is intended that the specification and examples be considered as exemplary only, with a true scope of the present invention being indicated by the following claims and their equivalents.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A local area network control system based on Bluetooth and user datagram protocol, comprising:
a plurality of first Bluetooth devices;
a first gateway configured to manage the first Bluetooth devices;
a plurality of second Bluetooth devices;
a second gateway configured to manage the second Bluetooth devices; and
a control device;
wherein the first gateway is configured to broadcast an information exchange request message based on a user datagram protocol, and the second gateway is configured to receive and analyze the information exchange request message to obtain a gateway information of the first gateway, and return an information message based on the user datagram protocol to the first gateway, wherein the first gateway is configured to receive and analyze the information message to obtain a gateway information of the second gateway, and the control device is configured to control one or more of the first Bluetooth devices and the second Bluetooth devices via either the first gateway or the second gateway.

2. The local area network control system based on Bluetooth and user datagram protocol as claimed in claim 1, wherein the gateway information of the first gateway comprises an Internet address of the first gateway and a routing information of the first Bluetooth devices.

3. The local area network control system based on Bluetooth and user datagram protocol as claimed in claim 2, further comprising a second local database, wherein the second gateway is configured to save the routing information of the first Bluetooth devices in the second local database and return the information message to the first gateway in a unicast manner based on the user datagram protocol according to the Internet address of the first gateway, whereby the second gateway has the routing information of the first Bluetooth devices and a routing information of the second Bluetooth devices.

4. The local area network control system based on Bluetooth and user datagram protocol as claimed in claim 1, wherein the gateway information of the second gateway comprises an Internet address of the second gateway and a routing information of the second Bluetooth devices.

5. The local area network control system based on Bluetooth and user datagram protocol as claimed in claim 4, further comprising a first local database, wherein the first gateway is configured to save the routing information of the second Bluetooth devices in the first local database and return a confirmation message to the second gateway in a unicast manner based on the user datagram protocol according to the Internet address of the second gateway, whereby the first gateway has the routing information of the first Bluetooth devices and the routing information of the second Bluetooth devices.

6. A local area network control method based on Bluetooth and user datagram protocol, comprising:
broadcasting an information exchange request message based on a user datagram protocol by a first gateway configured to manage a plurality of first Bluetooth devices;
receiving and analyzing the information exchange request message by a second gateway configured to manage a plurality of second Bluetooth devices to obtain a gateway information of the first gateway, and returning an information message based on the user datagram protocol to the first gateway;
receiving and analyzing the information message by the first gateway to obtain a gateway information of the second gateway; and
controlling one or more of the first Bluetooth devices and the second Bluetooth devices by a control device via either the first gateway or the second gateway.

7. The local area network control method based on Bluetooth and user datagram protocol as claimed in claim 6, wherein the gateway information of the first gateway comprises an Internet address of the first gateway and a routing information of the first Bluetooth devices.

8. The local area network control method based on Bluetooth and user datagram protocol as claimed in claim 7, wherein a step of receiving and analyzing the information exchange request message by the second gateway configured to manage the second Bluetooth devices to obtain the gateway information of the first gateway, and returning the information message based on the user datagram protocol to the first gateway further comprises:
saving the routing information of the first Bluetooth devices in a second local database via the second gateway; and
returning the information message to the first gateway in a unicast manner based on the user datagram protocol according to the Internet address of the first gateway by the second gateway, whereby the second gateway has the routing information of the first Bluetooth devices and a routing information of the second Bluetooth devices.

9. The local area network control method based on Bluetooth and user datagram protocol as claimed in claim 6, wherein the gateway information of the second gateway comprises an Internet address of the second gateway and a routing information of the second Bluetooth devices.

10. The local area network control method based on Bluetooth and user datagram protocol as claimed in claim 9, further comprising:
saving the routing information of the second Bluetooth devices in a first local database by the first gateway; and
returning a confirmation message to the second gateway in a unicast manner based on the user datagram protocol according to the Internet address of the second gateway by the first gateway, whereby the first gateway has the routing information of the first Bluetooth devices and the routing information of the second Bluetooth devices.
